(19) United States
(12) Patent Application Publication
(10) Pub. No.: US 2025/0369175 A1
(43) Pub. Date: Dec. 4, 2025

(54) WATER SUPPLY AND DRAIN BOX FOR WASHING MACHINE

(71) Applicant: TAIZHOU JINQUAN COPPER INCORPORATED COMPANY, YUHUAN (CN)

(72) Inventor: CAIYOU SUN, YUHUAN (CN)

(21) Appl. No.: 18/754,695

(22) Filed: Jun. 26, 2024

(30) Foreign Application Priority Data
Jun. 4, 2024 (CN) 202421266593.1

(51) Int. Cl. D06F 39/08

(52) U.S. Cl. CPC D06F 39/088; D06F 39/083

(57) ABSTRACT

The disclosure discloses a water supply and drain box for a washing machine, and belongs to the technical field of pipe fittings. The water supply and drain box includes a box body, where an installation chamber is formed inside the box body; at least two installation hole groups are formed in inner walls of the installation chamber; and each of the installation hole groups includes an assembly hole I, an assembly hole II and a drain hole arranged in different orders. A user may select the corresponding installation hole group according to actual needs, and the remaining installation hole group does not require user intervention. The water supply and drain box is applicable for installation in two or three different manners of arrangement, can meet the requirements of distribution of most water supply and drain pipelines of users, and has better installation applicability.

### TECHNICAL FIELD

The present disclosure belongs to the technical field of pipe fittings, and in particular to a water supply and drain box for a washing machine.

### BACKGROUND

Water supply pipelines and drain pipelines of sinks, washbasins and washing machines are often connected together in a wall through water supply and drain boxes for the convenience of user management and maintenance.

A “Plumbing drain assembly” disclosed in the US patent with the publication number U.S. Pat. No. 9,534,363B2 includes a pipe water outlet box, a Y-shaped connector and an air inlet valve. The pipe water outlet box is provided with a back wall and four side walls extending outwards from the back wall to form a chamber. The pipe water outlet box is to be embedded into a wall, and a drain outlet and two water inlets are formed in the side walls of the pipe water outlet box. The drain outlet is positioned between the two water inlets and connected to a drain pipe. The Y-shaped connector is arranged in the drain outlet, and the air inlet valve is arranged on the Y-shaped connector. Water valves are arranged in both the two water inlets, and the two water valves are respectively connected to a cold-water supply pipe and a hot-water supply pipe, allowing the two water valves to independently control the supply of cold water and hot water to a washing machine. The drain pipe of the washing machine is inserted into the Y-shaped connector, and sewage in the washing machine can be discharged through the drain outlet.

However, the positions of the drain outlet and the two water inlets of the aforementioned pipe water outlet box (equivalent to a water supply and drain box) are fixed and cannot be adjusted by users, so that the users can only install the corresponding cold-water supply pipe, hot-water supply pipe and drain pipe according to the positions of the three openings, with only one manner of installation. If the users need to change the arrangement order of the cold-water supply pipe, the hot-water supply pipe and the drain pipe according to the actual installation environment, for example, to install the drain pipe on one side and one of the cold-water supply pipe and the hot-water supply pipe in the middle to make the cold-water supply pipe and the hot-water supply pipe adjacent, it is difficult for the aforementioned water supply and drain box to meet the users' installation requirements. The aforementioned water supply and drain box has a limited range of applications and cannot meet most users' installation requirements.

### SUMMARY

The objective of the present disclosure is to provide a water supply and drain box for a washing machine in response to the aforementioned problems existing in the prior art, and the technical problem to be solved by the present disclosure is how to improve the installation applicability of the water supply and drain box.

The aforementioned technical objective of the present disclosure can be achieved by the following technical solution:

A water supply and drain box for a washing machine is provided, including a box body, where an installation chamber is formed inside the box body; at least two installation hole groups are formed in inner walls of the installation chamber; each of the installations hole group includes an assembly hole I, an assembly hole II and a drain hole; the assembly holes I, the assembly holes II and the drain holes of the installation hole groups are arranged in different orders; the assembly hole I is used for installing an angle valve I; the assembly hole II is used for installing an angle valve II; and the drain hole is used for drainage.

In the aforementioned water supply and drain box, each of the installation hole groups occupies an inner wall of the installation chamber.

In the aforementioned water supply and drain box, a joint I is detachably connected in the assembly hole I; a through hole I and a limit groove I connected to each other are formed in the joint I; the through hole I is used for inserting the angle valve I; the limit groove I is capable of limiting a protrusion I of the angle valve I circumferentially; a joint II is detachably connected in the assembly hole II; a through hole II and a limit groove II connected to each other are formed in the joint II; the through hole II is used for inserting the angle valve II; the limit groove II is capable of limiting a protrusion II of the angle valve II circumferentially; and a cover is detachably connected in the drain hole.

In the aforementioned water supply and drain box, a flange I and convex ribs I are formed at one end of the joint I inside the installation chamber; a flange II and convex ribs II are formed at one end of the joint II inside the installation chamber; both the flange I and the flange II are capable of abutting against the inner wall of the installation chamber; and convex ribs III are formed at one end of the cover inside the installation chamber.

In the aforementioned water supply and drain box, the angle valve I is connected with a lock nut I; the lock nut I fits with the protrusion I to limit the angle valve I axially; a groove I is formed at one end of the joint I outside the installation chamber; the groove I is capable of accommodating the lock nut I; the angle valve II is connected with a lock nut II; the lock nut II fits with the protrusion II to limit the angle valve II axially; a groove II is formed at one end of the joint II outside the installation chamber; and the groove II is capable of accommodating the lock nut II.

In the aforementioned water supply and drain box, two inner spiral fins I spaced apart are formed in the assembly hole I; outer spiral fins I capable of being tightened with the inner spiral fins I are formed on an outer wall of the joint I; two inner spiral fins II spaced apart are formed in the assembly hole II; and outer spiral fins II capable of being tightened with the inner spiral fins II are formed on an outer wall of the joint II.

In the aforementioned water supply and drain box, inner spiral fins III are formed in the drain hole, and outer spiral fins III capable of being tightened with the inner spiral fins III are formed on an outer wall of the cover.

In the aforementioned water supply and drain box, a triangular convex block I is formed on the outer wall of the joint I close to the flange I; a positioning groove I is formed at one end of the inner spiral fin I; after the inner spiral fins I are tightened with the outer spiral fins I, the triangular convex block I fits with the positioning groove I to limit the joint I circumferentially; a triangular convex block II is formed on the outer wall of the joint II close to the flange II; a positioning groove II is formed at one end of the inner spiral fin II; and after the inner spiral fins II are tightened with the outer spiral fins II, the triangular convex block II fits with the positioning groove II to limit the joint II circumferentially.

In the aforementioned water supply and drain box, a stop block I is formed on the outer wall of the joint I close to the triangular convex block I; after the triangular convex block I enters the positioning groove I, the stop block I abuts tight against the end of the inner spiral fin I; a stop block II is formed on the outer wall of the joint II close to the triangular convex block II; and after the triangular convex block II enters the positioning groove II, the stop block II abuts tight against the end of the inner spiral fin II.

In the aforementioned water supply and drain box, an extension pipe connected to the drain hole is arranged on an outer wall of the box body.

Based on the above, compared to the prior art, the beneficial effects of the present disclosure are as follows:

The water supply and drain box for a washing machine is provided with at least two installation hole groups. The assembly holes I, the assembly holes I and the drain holes of each of the installation hole groups are arranged in different orders, and each of the installation hole groups can be used for installing the angle valve I, the angle valve II and a drain pipe of the washing machine. A user may face the corresponding installation hole group towards the ground and embed the box body into a wall according to actual needs, so that the angle valve I, the angle valve II and the drain pipe of the washing machine can be installed in the installation hole group. The remaining installation hole group does not require user intervention. The water supply and drain box is applicable for installation in two or three different manners of arrangement, can meet the requirements of distribution of most water supply pipelines and drain pipelines of users, and has better installation applicability.

Moreover, the angle valve I may be connected in the assembly holes I of different installation hole groups through the joint I, and the angle valve II may be connected in the assembly holes II of different installation hole groups through the joint II. The angle valve I and the angle valve II are convenient to replace, and the unused drainage hole is covered by the cover. In addition, the joint I is further limited by the triangular convex block I and the positioning groove I, so the joint I is more stable in the assembly hole I. Accordingly, after the triangular convex block II is clamped into the positioning groove II, the joint II is more stable in the assembly hole II, and the joint I and the joint II are not likely to loosen. Even if the user opens and closes the angle valve I and the angle valve II multiple times, it will not cause the angle valve I and the angle valve II to loosen.

### BRIEF DESCRIPTION OF FIGURES

FIG. 1 is a partial exploded schematic diagram of an embodiment.

FIG. 2 is a schematic structural diagram of a box body.

FIG. 3 is a schematic structural diagram of a joint I.

FIG. 4 is a schematic structural diagram of a joint II.

FIG. 5 is a schematic diagram of an exploded structure of an angle valve I and the joint I.

FIG. 6 is a sectional schematic diagram of an angle valve II and the joint II after assembling.

FIG. 7 is a schematic diagram I of an external structure of the embodiment.

FIG. 8 is a sectional schematic diagram of FIG. 7.

FIG. 9 is a schematic diagram II of the exploded structure of the embodiment.

FIG. 10 is a sectional schematic diagram of FIG. 9.

FIG. 11 is a schematic diagram II of the external structure of the embodiment.

Reference numbers in the drawings: 1, angle valve I; 11, protrusion I; 12, lock nut I; 2, angle valve II; 21, protrusion II; 22, lock nut II;
100, box body; 110, extension pipe; 120, lug;
200, installation chamber; 210, panel; 211, clearance hole;
300, installation hole group; 310, assembly hole I; 311, inner spiral fin I; 312, positioning groove I; 320, assembly hole II; 321, inner spiral fin II; 322, positioning groove II; 330, drain hole; 331, inner spiral fin III;
400, joint I; 410, through hole I; 420, limit groove I; 430, flange I; 440, convex rib I; 450, groove I; 460, outer spiral fin I; 470, triangular convex block I; 480, stop block I;
500, joint II; 510, through hole II; 520, limit groove II; 530, flange II; 540, convex rib II; 550, groove II; 560, outer spiral fin II; 570, triangular convex block II; 580, stop block II;
600, cover; 610, flange III; 620, convex rib III; and 630, outer spiral fin III.

### DETAILED DESCRIPTION

Specific embodiments of the present disclosure are provided below to further describe the technical solution of the present disclosure in conjunction with the accompanying drawings, but the present disclosure is not limited to the following embodiments.

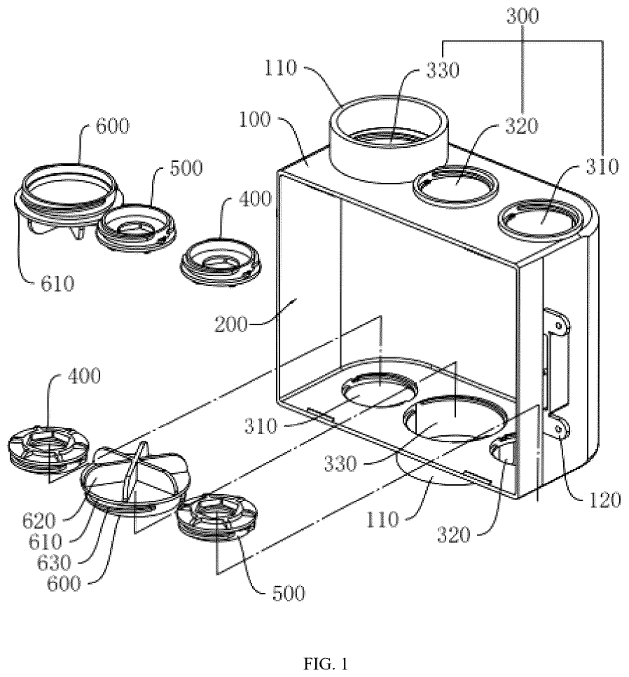

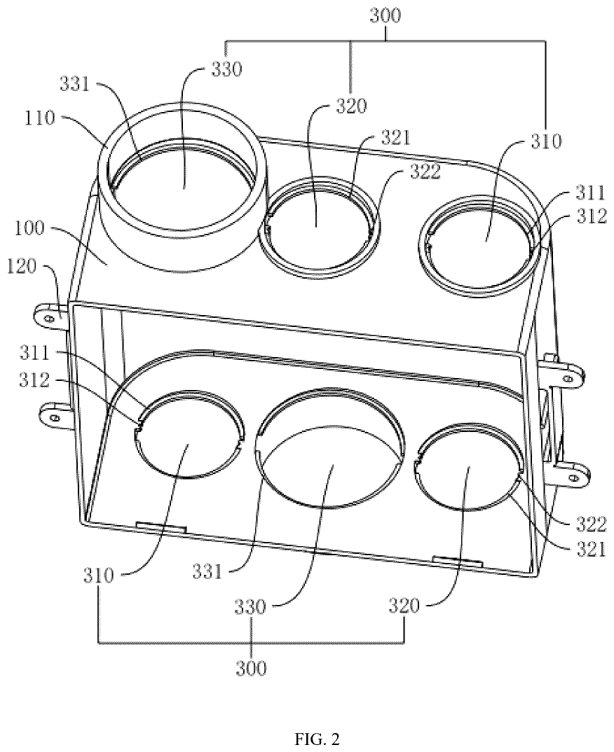

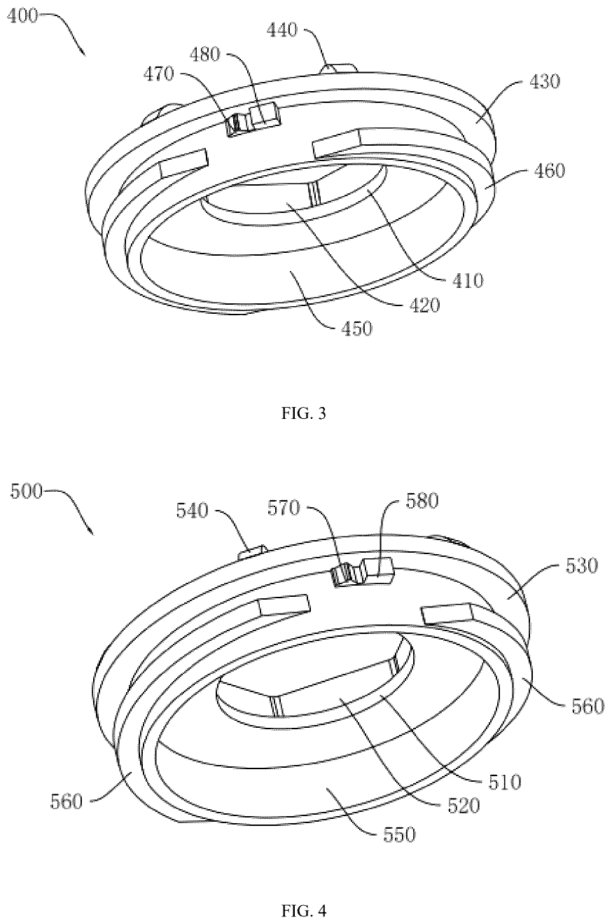

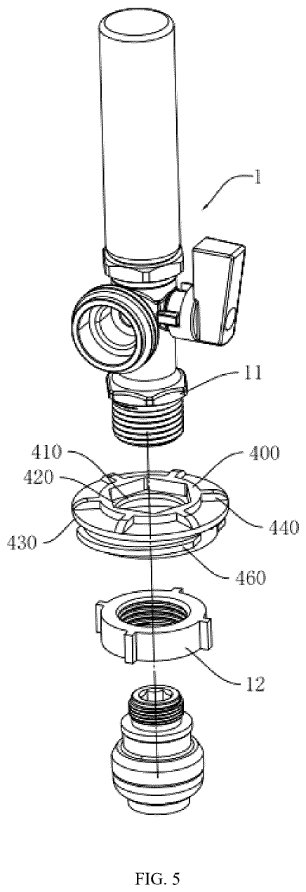

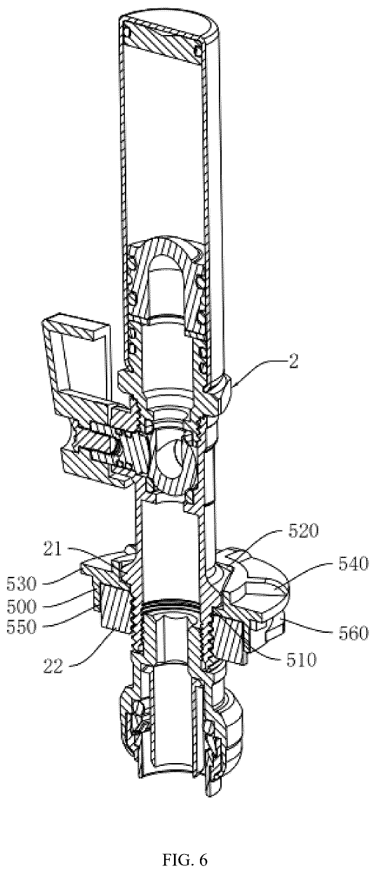

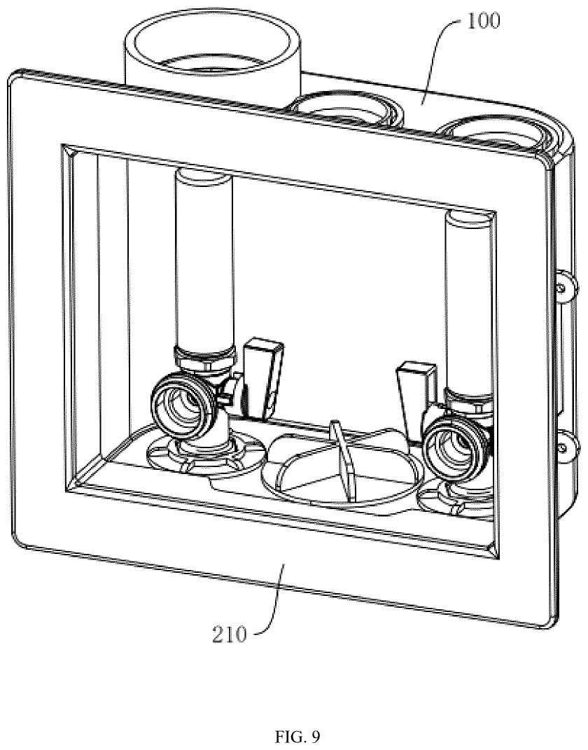

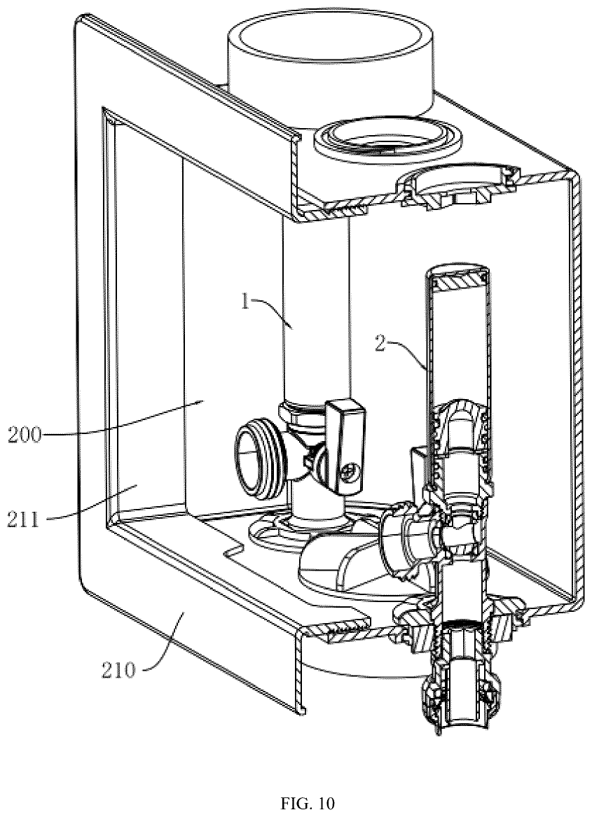

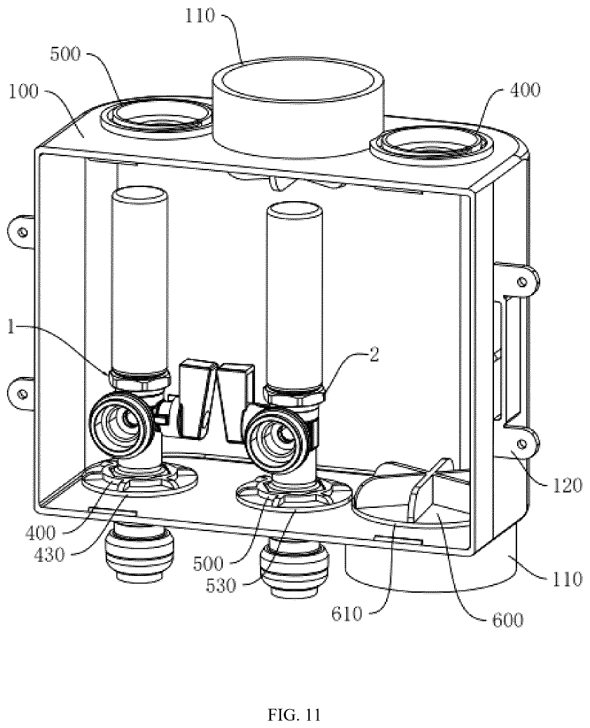

As shown in FIG. 1 to FIG. 11, a water supply and drain box for a washing machine is provided, including a box body 100. An installation chamber 200 is formed inside the box body 100. At least two installation hole groups 300 are formed in inner walls of the installation chamber 200. Each of the installation hole groups 300 includes an assembly hole I 310, an assembly hole II 320 and a drain hole 330. The assembly holes I 310, the assembly holes II 320 and the drain holes 330 of the installation hole groups 300 are arranged in different orders. For example, as shown in FIG. 1 to FIG. 2, the drain hole 330 of one installation hole group 300 is arranged between the assembly hole I 310 and the assembly hole II 320; and the drain hole 330 of the other installation hole group 300 is arranged on a left side and the assembly hole I 310 and the assembly hole II 320 are arranged side by side on a right side, or the drain hole 330 is arranged on the right side and the assembly hole I 310 and the assembly hole II 320 are arranged side by side on the left side.

The assembly hole I 310 is used for installing an angle valve I 1, the assembly hole II 320 is used for installing an angle valve II 2, and the drain hole 330 is used for installing a drain pipe of a sink, a washbasin or a washing machine. Both the angle valve I 1 and the angle valve II 2 belong to the prior art, and may be water hammer-proof angle valves specifically. Each of the installation hole groups 300 occupies an inner wall of the installation chamber 200, and the assembly hole I 310, the assembly hole II 320, and the drain hole 330 of each of the installation hole groups 300 are spaced apart. In some implementations, two installation hole groups 300 are arranged, and the two installation hole groups 300 are distributed on two opposite inner walls in the installation chamber 200.

As shown in FIG. 1 to FIG. 9, a joint I 400 is detachably connected in the assembly hole I 310. A through hole I 410 and a limit groove I 420 connected to each other are formed in the joint I 400. The through hole I 410 is used for inserting the angle valve I 1. The limit groove I 420 fits with a protrusion I 11 of the angle valve I 1 and is capable of limiting the protrusion I 11 circumferentially. A joint II 500 is detachably connected in the assembly hole II 320. A through hole II 510 and a limit groove II 520 connected to each other are formed in the joint II 500. The through hole II 510 is used for inserting the angle valve II 2. The limit groove II 520 fits with a protrusion II 21 of the angle valve II 2 and is capable of limiting the protrusion II 21 circumferentially. A cover 600 is detachably connected in the drain hole 330, and the cover 600 can cover the drain hole 330.

Specifically, a flange I 430 and convex ribs I 440 are formed at one end of the joint I 400 inside the installation chamber 200. A flange II 530 and convex ribs II 540 are formed at one end of the joint II 500 inside the installation chamber 200. A flange III 610 and convex ribs III 620 are formed at one end of the cover 600 inside the installation chamber 200. The flange I 430, the flange II 530 and the flange III 610 can abut against the inner wall of the installation chamber 200. The convex ribs I 440, the convex ribs II 540 and the convex ribs III 620 can be grasped by user's fingers. The user can apply a force to the convex ribs I 440 through fingers to drive the convex ribs I 440 and the joint I 400 to rotate integrally. The joint II 500 can be driven to rotate by rotating the convex ribs II 540. Accordingly, the cover 600 can be driven to rotate by rotating the convex ribs III 620.

A lower end of the angle valve I 1 is connected with a lock nut I 12, and the lock nut I 12 fits with the protrusion I 11 to clamp the angle valve I 1 onto the joint I 400, thereby limiting the angle valve I 1 axially. A groove I 450 is formed at one end of the joint I 400 outside the installation chamber 200. The groove I 450 is capable of accommodating the lock nut I 12. A lower end of the angle valve II 2 is connected with a lock nut II 22, and the lock nut II 22 fits with the protrusion II 21 to clamp the angle valve II 2 onto the joint II 500, thereby limiting the angle valve II 2 axially. A groove II 550 is formed at one end of the joint II 500 outside the installation chamber 200. The groove II 550 is capable of accommodating the lock nut II 22. After being connected, the angle valve I 1, the joint I 400 and the lock nut I 12 can be connected as a whole component in different assembly holes I 310. After being connected, the angle valve II 2, the joint II 500 and the lock nut II 22 can be connected as a whole component in different assembly holes II 320. As an alternative solution, the angle valve I 1 may be threaded into the through hole I 410, and the angle valve II 2 may be threaded into the through hole II 510, thereby omitting the lock nut I 12 and the lock nut II 22.

As shown in FIG. 1 to FIG. 7, two inner spiral fins I 311 spaced apart are formed circumferentially in the assembly hole I 310. The two inner spiral fins I 311 are not connected and have a gap therebetween. Outer spiral fins I 460 capable of being tightened with the inner spiral fins I 311 are formed on an outer wall of the joint I 400. Two inner spiral fins II 321 spaced apart are formed circumferentially in the assembly hole II 320. The two inner spiral fins II 321 are not connected and have a gap therebetween. Outer spiral fins II 560 capable of being tightened with the inner spiral fins II 321 are formed on an outer wall of the joint II 500.

Inner spiral fins III 331 are formed in the drain hole 330, and outer spiral fins III 630 capable of being tightened with the inner spiral fins III 331 are formed on an outer wall of the cover 600. As an alternative solution, the joint I 400 can be connected to the assembly hole I 310, the joint II 500 can be connected to the assembly hole II 320, and the cover 600 can be connected to the drain hole 330, through snap fit.

As shown in FIG. 1 to FIG. 7, further, a triangular convex block I 470 is formed on the outer wall of the joint I 400 close to the flange I 430. A positioning groove I 312 is formed at one end of the inner spiral fin I 311 close to the installation chamber 200. After the inner spiral fins I 311 are tightened with the outer spiral fins I 460, the triangular convex block I 470 is clamped into the positioning groove I 312 to limit the joint I 400 circumferentially. Therefore, the joint I 400 cannot be further screwed in or out of the assembly hole I 310 to prevent the joint I 400 from loosening in the assembly hole I 310. The triangular convex block I 470 can be rotated out of the positioning groove I 312 only by increasing the force applied to the joint I 400 and rotating the joint I in reverse, and then the joint I 400 can be rotated out of the assembly hole I 310 normally. A triangular convex block II 570 is formed on the outer wall of the joint II 500 close to the flange II 530. A positioning groove II 322 is formed at one end of the inner spiral fin II 321 close to the installation chamber 200. After the inner spiral fins II 321 are tightened with the outer spiral fins II 560, the triangular convex block II 570 is clamped into the positioning groove II 322 to limit the joint II 500 circumferentially. Therefore, the joint II 500 cannot be further screwed in or out of the assembly hole II 320 to prevent the joint II 500 from loosening in the assembly hole II 320. The triangular convex block II 570 can be rotated out of the positioning groove II 322 only by increasing the force applied to the joint II 500 and rotating the joint II in reverse, and then the joint II 500 can be rotated out of the assembly hole II 320 normally.

A stop block I 480 is formed on the outer wall of the joint I 400 close to the triangular convex block I 470. After the triangular convex block I 470 enters the positioning groove I 312, the stop block I 480 abuts tight against the end of the inner spiral fin I 311, thereby further improving the stability of the joint I 400. A stop block II 580 is formed on the outer wall of the joint II 500 close to the triangular convex block II 570. After the triangular convex block II 570 enters the positioning groove II 322, the stop block II 580 abuts tight against the end of the inner spiral fin II 321, thereby further improving the stability of the joint II 500.

In some implementations, the assembly hole I 310 and the assembly hole II 320 have a same structure, the joint I 400 and the joint II 500 also have a same structure, and the joint I 400 and the joint II 500 are interchangeably used.

An extension pipe 110 connected to the drain hole 330 is arranged on an outer wall of the box body 100. The drain hole 330 is perpendicular to the ground.

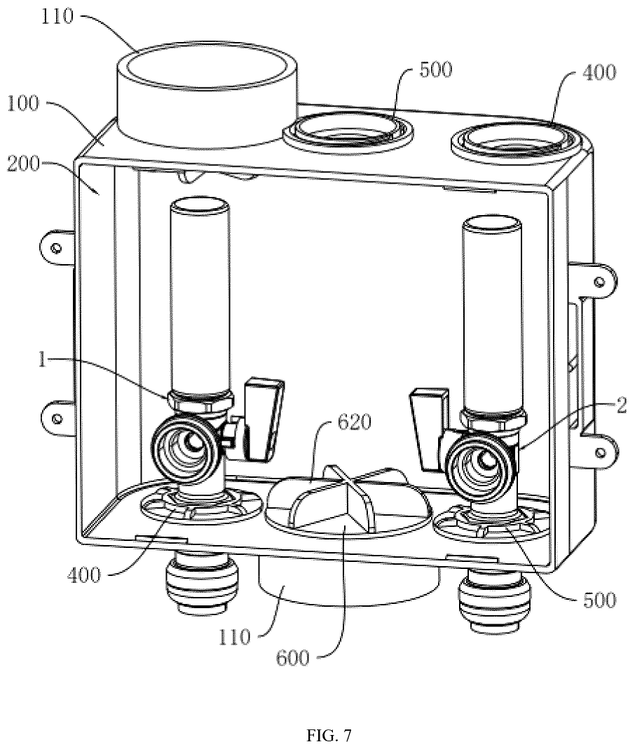

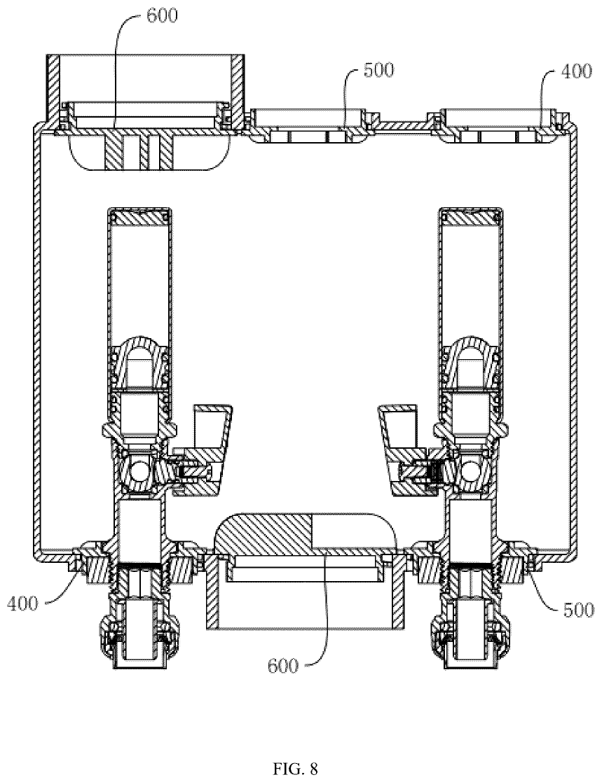

As shown in FIG. 2 and FIG. 7, a plurality of lugs 120 are formed on outer sides of the box body 100, and the lugs 120 are used for installing the box body 100 in a wall or a bracket. A panel 210 is clamped to an opening of the installation chamber 200, and the panel 210 has a clearance hole 211 connected to the installation chamber 200.

The working principle of the present disclosure is as follows:

The corresponding installation hole group 300 (e.g., the installation hole group 300 with the drain hole 330 between the assembly hole I 310 and the assembly hole II 320) is selected based on user's usage habits or actual installation conditions. As shown in FIG. 7 and FIG. 8, an installation direction of the box body 100 is adjusted, so that the selected installation hole group 300 faces the ground, that is, the selected assembly hole I 310, assembly hole II 320 and drain hole 330 are all close to the ground.

The angle valve I 1, the joint I 400 and the lock nut I 12 are connected into a whole component and screwed into the assembly hole I 310 through the joint I 400 until the triangular convex block I 470 enters the positioning groove I 312. Then a water supply pipe (e.g., a cold-water pipe) is connected to the lower end of the angle valve I 1.

Similarly, the angle valve II 2, the joint II 500 and the lock nut II 22 are connected into a whole component and screwed into the assembly hole II 320 through the joint II 500 until the triangular convex block II 570 enters the positioning groove II 322. Then another water supply pipe (e.g., a hot-water pipe) supplies water for the angle valve II 2.

The cover 600 is screwed out of the drain hole 330, and a drain pipe of a washing machine is inserted into the drain hole 330. Thus, installation of the water supply and drain box is achieved.

Due to the fact that the water supply and drain box for a washing machine is provided with the two or more installation hole groups 300, and the assembly holes I 310, the assembly holes II 320 and the drain holes 330 of each of the installation hole groups 300 are arranged in different manners, more optional manners of installation are provided for users, and the water supply and drain box has a wide range of applications. It should be noted that the water supply and drain box for a washing machine may also be used in conjunction with a sink or a washbasin.

The specific embodiments described herein are only illustrative examples of the spirit of the present disclosure. Those skilled in the technical field to which the present disclosure belongs may make various modifications or supplements to the specific embodiments described, or use similar methods for replacement, without deviating from the spirit of the present disclosure or exceeding the scope defined in the attached claims.

What is claimed is:

1. A water supply and drain box for a washing machine, comprising a box body (100), wherein an installation chamber (200) is formed inside the box body (100); at least two installation hole groups (300) are formed in inner walls of the installation chamber (200); each of the installation hole groups (300) comprises an assembly hole I (310), an assembly hole II (320) and a drain hole (330); the assembly holes I (310), the assembly holes II (320) and the drain holes (330) of the installation hole groups (300) are arranged in different orders; the assembly hole I (310) is used for installing an angle valve I (1); the assembly hole II (320) is used for installing an angle valve II (2); and the drain hole (330) is used for drainage.

2. The water supply and drain box according to claim 1, wherein each of the installation hole groups (300) occupies an inner wall of the installation chamber (200).

3. The water supply and drain box according to claim 1, wherein a joint I (400) is detachably connected in the assembly hole I (310); a through hole I (410) and a limit groove I (420) connected to each other are formed in the joint I (400); the through hole I (410) is used for inserting the angle valve I (1); the limit groove I (420) is capable of limiting a protrusion I (11) of the angle valve I (1) circumferentially; a joint II (500) is detachably connected in the assembly hole II (320); a through hole II (510) and a limit groove II (520) connected to each other are formed in the joint II (500); the through hole II (510) is used for inserting the angle valve II (2); the limit groove II (520) is capable of limiting a protrusion II (21) of the angle valve II (2) circumferentially; and a cover (600) is detachably connected in the drain hole (330).

4. The water supply and drain box according to claim 3, wherein a flange I (430) and convex ribs I (440) are formed at one end of the joint I (400) inside the installation chamber (200); a flange II (530) and convex ribs II (540) are formed at one end of the joint II (500) inside the installation chamber (200); both the flange I (430) and the flange II (530) are capable of abutting against the inner wall of the installation chamber (200); and convex ribs III (620) are formed at one end of the cover (600) inside the installation chamber (200).

5. The water supply and drain box according to claim 3, wherein the angle valve I (1) is connected with a lock nut I (12); the lock nut I (12) fits with the protrusion I (11) to limit the angle valve I (1) axially; a groove I (450) is formed at one end of the joint I (400) outside the installation chamber (200); the groove I (450) is capable of accommodating the lock nut I (12); the angle valve II (2) is connected with a lock nut II (22); the lock nut II (22) fits with the protrusion II (21) to limit the angle valve II (2) axially; a groove II (550) is formed at one end of the joint II (500) outside the installation chamber (200); and the groove II (550) is capable of accommodating the lock nut II (22).

6. The water supply and drain box according to claim 4, wherein two inner spiral fins I (311) spaced apart are formed in the assembly hole I (310); outer spiral fins I (460) capable of being tightened with the inner spiral fins I (311) are formed on an outer wall of the joint I (400); two inner spiral fins II (321) spaced apart are formed in the assembly hole II (320); and outer spiral fins II (560) capable of being tightened with the inner spiral fins II (321) are formed on an outer wall of the joint II (500).

7. The water supply and drain box according to claim 4, wherein inner spiral fins III (331) are formed in the drain hole (330), and outer spiral fins III (630) capable of being tightened with the inner spiral fins III (331) are formed on an outer wall of the cover (600).

8. The water supply and drain box according to claim 6, wherein a triangular convex block I (470) is formed on the outer wall of the joint I (400) close to the flange I (430); a positioning groove I (312) is formed at one end of the inner spiral fin I (311); after the inner spiral fins I (311) are tightened with the outer spiral fins I (460), the triangular convex block I (470) fits with the positioning groove I (312) to limit the joint I (400) circumferentially; a triangular convex block II (570) is formed on the outer wall of the joint II (500) close to the flange II (530); a positioning groove II (322) is formed at one end of the inner spiral fin II (321); and after the inner spiral fins II (321) are tightened with the outer spiral fins II (560), the triangular convex block II (570) fits with the positioning groove II (322) to limit the joint II (500) circumferentially.

9. The water supply and drain box according to claim 8, wherein a stop block I (480) is formed on the outer wall of the joint I (400) close to the triangular convex block I (470); after the triangular convex block I (470) enters the positioning groove I (312), the stop block I (480) abuts tight against the end of the inner spiral fin I (311); a stop block II (580) is formed on the outer wall of the joint II (500) close to the triangular convex block II (570); and after the triangular convex block II (570) enters the positioning groove II (322), the stop block II (580) abuts tight against the end of the inner spiral fin II (321).

10. The water supply and drain box according to claim 1, wherein an extension pipe (110) connected to the drain hole (330) is arranged on an outer wall of the box body (100).
